(19) United States
(12) Patent Application Publication
(10) Pub. No.: US 2016/0267589 A1
(43) Pub. Date: Sep. 15, 2016

(54) Method and System for Managing Online Bidding

(71) Applicant: Yahoo! Inc., Sunnyvale, CA (US)

(72) Inventors: Ray Wang, Beijing (CN); Lixing Bo, Beijing (CN); Choon Kit Chan, Beijing (CN)

(21) Appl. No.: 14/412,033

(22) PCT Filed: Jan. 15, 2014
(86) PCT No.: PCT/CN2014/070666

§ 371 Date: Dec. 30, 2014

(51) Int. Cl. G06Q 40/04

(52) U.S. Cl. CPC G06Q 40/04

(57) ABSTRACT

Method and system for managing online bidding are provided. A bid request is received via the communication platform. The bid request is analyzed to obtain information associated with the request. Whether to participate in online bidding is determined based on a bid control model in accordance with the information associated with the request. The bid control model is generated based on historical data associated with one or more previous online bidding events. An online bid is generated if it is determined to participate in the online bidding. The online bid is transmitted as a response to the bid request.

### BACKGROUND

1. Technical Field

The present teaching relates generally to bidding. Specifically, the present teaching relates to method and system for managing online bidding.

2. Discussion of Technical Background

The advancement in the Internet has made it possible to sell and buy online products or services among users through the Internet. Online bidding is a method for buyers to bid on their interested online products or services. For example, when an opportunity for online display advertising is available at a publisher, a bid request is sent to an ad exchange engine. The ad exchange engine can conduct an online bidding among multiple advertisers, select a winner, and return a bid as a response to the bid request.

Effort has been made to reduce workload and cost of an ad exchange engine. A substantive part of the workload includes running an online bidding to determine a winner. However, conventional approaches did not include evaluating a bid request to determine whether to participate in online bidding. In addition, conventional approaches did not evaluate a bid request based on historical data from previous online bidding events. Furthermore, conventional approaches did not include generating and sending reports associated with online bidding to publishers and/or advertisers.

Therefore, there is a need for a method and system to manage online bidding and avoid the above drawbacks.

### SUMMARY

The present teaching describes methods, systems, and programming for managing online bidding.

In one exemplary embodiment, a method, implemented on at least one machine having at least one processor, storage, and a communication platform connected to a network for managing online bidding is provided. A bid request is received via the communication platform. The bid request is analyzed to obtain information associated with the request. Whether to participate in online bidding is determined based on a bid control model in accordance with the information associated with the request. The bid control model is generated based on historical data associated with one or more previous online bidding events. An online bid is generated if it is determined to participate in the online bidding. The online bid is transmitted as a response to the bid request.

In another exemplary embodiment, a system including at least one processor, storage, and a communication platform connected to a network for managing online bidding, is provided. The system comprises a bid request analyzer, a bid control module, and a bid server. The bid request analyzer is configured for receiving, via the communication platform, a bid request and analyzing the bid request to obtain information associated with the request. The bid control module is configured for determining whether to participate in online bidding based on a bid control model in accordance with the information associated with the request. The bid control model is generated based on historical data associated with one or more previous online bidding events. The bid server is configured for generating an online bid if it is determined to participate in the online bidding. The online bid is transmitted as a response to the bid request.

Other concepts relate to software for cross device notification. A software product, in accord with this concept, includes at least one machine-readable non-transitory medium and information carried by the medium.

In one exemplary embodiment, a machine-readable tangible and non-transitory medium having information for managing online bidding, wherein the information, when read by the machine, causes the machine to receive, via the communication platform, a bid request, analyze the bid request to obtain information associated with the request, determine whether to participate in online bidding based on a bid control model in accordance with the information associated with the request, wherein the bid control model is generated based on historical data associated with one or more previous online bidding events, generate an online bid if it is determined to participate in the online bidding, and transmit the online bid as a response to the bid request.

### BRIEF DESCRIPTION OF THE DRAWINGS

The embodiments will be more readily understood in view of the following description when accompanied by the below figures and wherein like reference numerals represent like elements, wherein:

FIG. 1 is a high level depiction of an exemplary system for managing online bidding, according to a first application embodiment of the present teaching;

FIG. 2 is a high level depiction of an exemplary system for managing online bidding, according to a second application embodiment of the present teaching;

FIG. 3 depicts a high level exemplary system diagram of an ad exchange engine, according to an embodiment of the present teaching;

FIG. 4 is a flow chart of an exemplary process for managing online bidding, in accordance with one embodiment of the present teaching;

FIG. 5 depicts a high level exemplary system diagram of a bid control module, according to an embodiment of the present teaching;

FIG. 6 is a flow chart of an exemplary process performed at a bid control module, according to an embodiment of the present teaching;

FIG. 7 depicts a high level exemplary system diagram of a reporting module, according to an embodiment of the present teaching;

FIG. 8 is a flow chart of an exemplary process performed at a reporting module, according to an embodiment of the present teaching;

FIG. 9 shows exemplary types of information included in bid control information, according to an embodiment of the present teaching; and

FIG. 10 depicts a general computer architecture on which the present teaching can be implemented.

### DETAILED DESCRIPTION

Reference will now be made in detail to the embodiments of the present teaching, examples of which are illustrated in the accompanying drawings. While the present teaching will be described in conjunction with the embodiments, it will be understood that they are not intended to limit the present teaching to these embodiments. On the contrary, the present teaching is intended to cover alternatives, modifications, and equivalents, which may be included within the spirit and scope of the present teaching as defined by the appended claims.

In addition, in the following detailed description of embodiments of the present teaching, numerous specific details are set forth in order to provide a thorough understanding of the present teaching. However, it will be recognized by one of ordinary skill in the art that the present teaching may be practiced without these specific details. In other instances, well-known methods, procedures, components, and circuits have not been described in detail as not to unnecessarily obscure aspects of the embodiments of the present teaching.

Various embodiments in accordance with the present teaching provide method and system related to online bidding. More specifically, the method and system in various embodiments of the present teaching relate to evaluating a bid request to determine whether to participate in online bidding based on a bid control model, before performing the online bidding.

It is very expensive for an ad exchange engine to perform an online bidding to determine a winner among many advertisers, especially for real-time bidding when online display advertising is sold and bought in real time. Thus it is a huge cost for the ad exchange engine to determine no bid will be returned after running through the entire online bidding event. This kind of cost can be avoided according to embodiments of the present teaching, where it can be determined not to participate in online bidding before actually running the online bidding.

Historical data associated with previous online bidding events are available before running a current online bidding. Thus, a bid control model can be generated offline based on the historical data, i.e., before or without receiving any bid request from a network, or even when disconnected from the network. The bid control model can be used to determine whether to participate in online bidding after receiving a bid request. If it is determined not to participate in online bidding, cost can be avoided by not running the online bidding. Even if it is determined to participate in online bidding, cost can still be avoided by qualifying the online bidding with some bid control information, e.g., performing the bidding merely among a specified subset of advertisers, who have bidding history related to the bid request.

In addition, reports about bidding events on an ad exchange engine can be generated and sent to publishers to inform them, e.g., what kind of bid request or advertising opportunity is more popular. Similarly, reports about bidding events can be generated and sent to advertisers to inform them, e.g., what would be a good price to win a bid they are interested in. Thus, by generating and sending reports periodically or upon request, an ad exchange engine can not only help exchanging advertisements, but also improve closing percentage of ad exchanges.

Additional features will be set forth in part in the description which follows, and in part will become apparent to those skilled in the art upon examination of the following and the accompanying drawings or may be learned by production or operation of the examples.

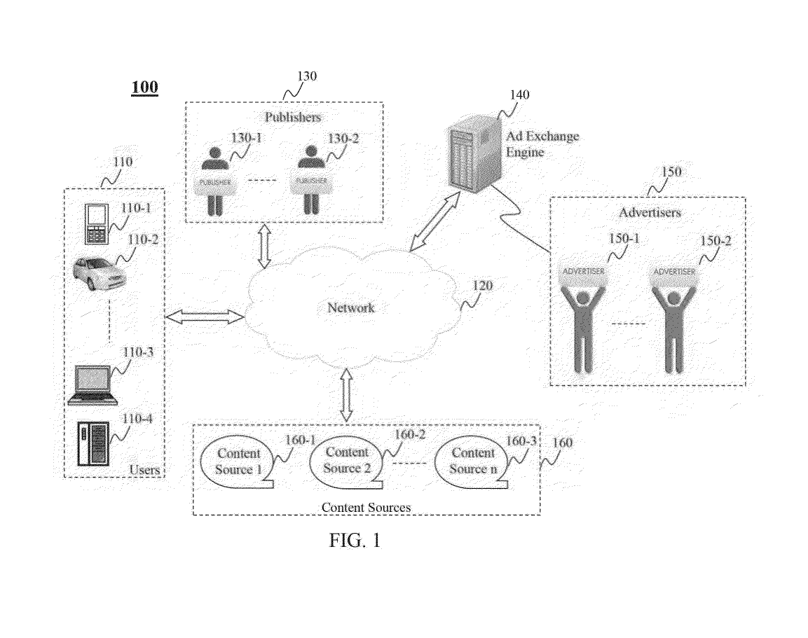

FIG. 1 is a high level depiction of an exemplary system 100 in which an ad exchange engine 140 is deployed to support online ad exchange, according to a first application embodiment of the present teaching. The exemplary system 100 includes users 110, a network 120, publishers 130, an ad exchange engine 140, advertisers 150, and content sources 160. The network 120 in system 100 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. In one embodiment, the network 120 can be an ad network, which connects advertisers 150 to publishers 130 that want to host advertisements. An ad network may be a television ad network, a print ad network, an online (Internet) ad network, or a mobile ad network.

Users 110 may be of different types such as users connected to the network via desktop connections (110-4), users connecting to the network via wireless connections such as through a laptop (110-3), a handheld mobile device (110-1), or a built-in device in a motor vehicle (110-2). A user, e.g., 110-1, may send a request for content to one of the publishers, e.g., 150-1, via the network 120 and receive content through the network 120.

Publishers 130 may correspond to an entity, whether an individual, a firm, or an organization, having publishing business, such as a television station, a newspaper issuer, or a web page host. For example, in connection to an online or mobile ad network, publishers 130 can be an organization such as USPTO.gov, a content provider such as cnn.com and Yahoo.com, or a content-feed source such as tweeter or blogs.

Referring to the above example, the content sent to user 110-1 may be generated by the publisher 150-1 based on the content sources 160. A content source may correspond to an entity where the content was originally generated. For example, a novel may be originally printed in a magazine, but then posted online at a web site controlled by a publisher. The content sources 160 in the exemplary system 100 include multiple content sources 160-1, 160-2 . . . 160-3.

When content is sent to the user 110-1, one or more advertising opportunities may be available in a web page where the content is presented. When an advertising opportunity is available, a bid request may be sent out regarding the advertising opportunity, whose metric is called an ad impression. For example, a real-time online bidding is usually for selling and buying online display advertising in real time one ad impression at a time. The bid request can be sent out by an ad server (not shown in FIG. 1) that manages the publisher 130-1. The ad server here serves as a supply side platform (SSP) for selling ads by soliciting bids from one or more demand side platforms (DSP) and selecting a winning bid among the bids received from the DSPs. The bid request may be sent out to one or more DSPs.

The ad exchange engine 140 can serve as one DSP for buying ads from an SSP, by running an internal bidding among advertisers 150 and submitting a bid to the SSP, after receiving a bid request from the SSP. Advertisers 150 may correspond to an entity, whether an individual, a firm, or an organization, doing or planning to do advertising business. For example, advertisers 150 may include companies like General Motors, Best Buy, or Disney.

In one embodiment, the advertisers 150 have stored their ads and bidding information at the ad exchange engine 140 that serves as a buyer agent for the advertisers 150. After receiving a bid request for an ad impression of an advertising opportunity, the ad exchange engine 140 can automatically run an internal online bidding among the advertisers 150 in real-time based on information stored therein, without actually asking bids from each of the advertisers 150. After the internal bidding within the ad exchange engine 140, a bid is selected and sent to the SSP or the corresponding publisher. Referring to the above example, the SSP or the publisher 130-1 may then select a highest bid from bids received from one or more ad exchange engines and present an ad associated with the highest bid along with the content sent to the user 110-1.

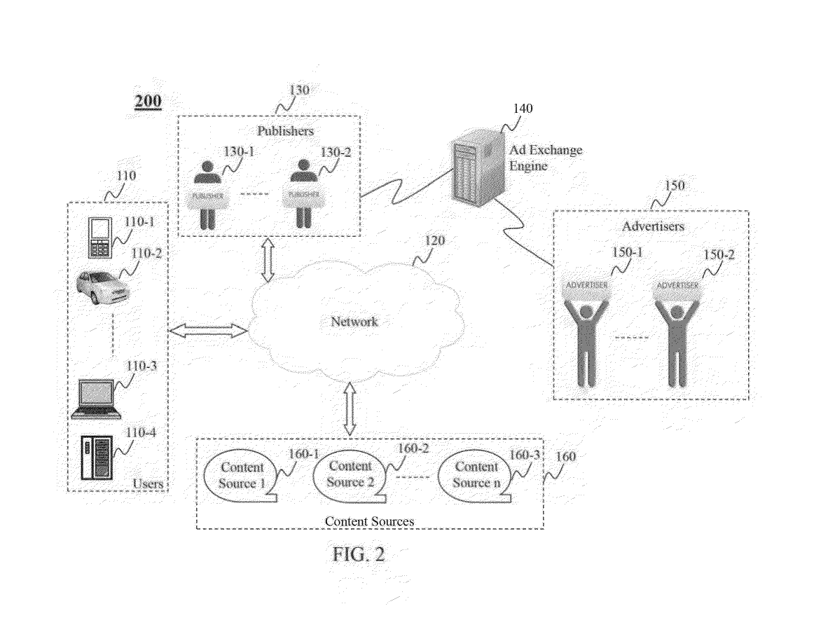

FIG. 2 is a high level depiction of an exemplary system 100 in which an ad exchange engine 140 is deployed to support online ad exchange, according to a second application embodiment of the present teaching. In this embodiment, the ad exchange engine 140 serves as a backend system of the publishers 130. For example, a company may serve both as a publisher for providing online advertising and requesting online bidding and as an ad exchange engine for supporting online ad exchange and running an online bidding for advertisers.

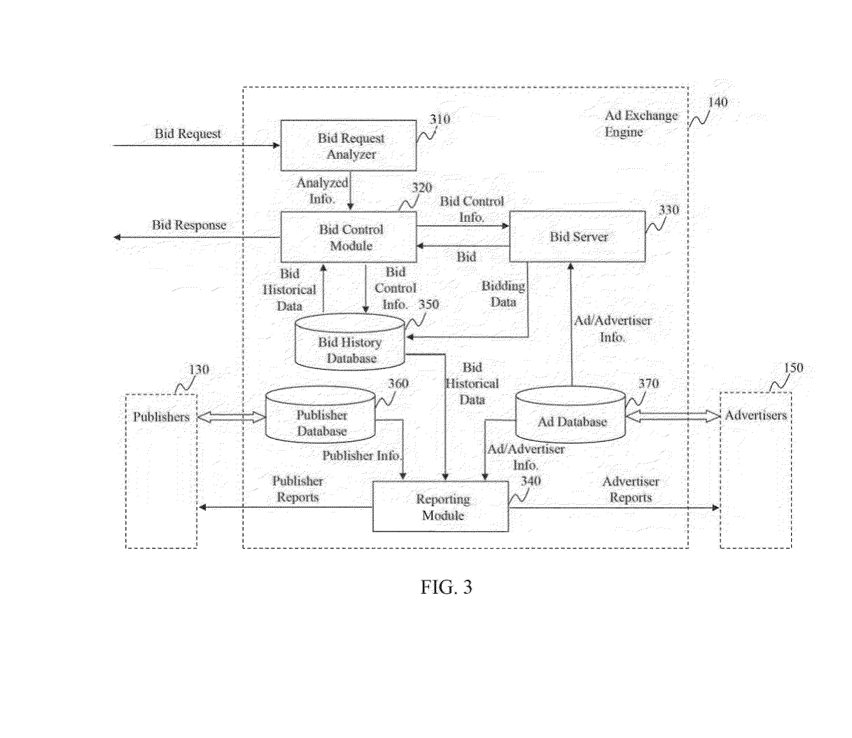

FIG. 3 depicts a high level exemplary system diagram of an ad exchange engine 140, according to an embodiment of the present teaching. The ad exchange engine 140 in this embodiment includes a bid request analyzer 310, a bid control module 320, a bid server 330, a reporting module 340, a bid history database 350, a publisher database 360, and an ad database 370.

The bid request analyzer 310 is configured for receiving and analyzing a bid request, from a publisher via an SSP. In one embodiment, a bid request corresponds to an ad impression of advertising at the publisher's web site. The bid request analyzer 310 can analyze the bid request to obtain analyzed information including but not limited to features of the ad impression, features of the publisher, and features of the web site. The features of the ad impression may comprise e.g., location of the ad impression in the web site, lasting time for this impression, and categories or formats of the ad impression such as text, video, or audio. The features of the publisher may comprise e.g., total number of registered users of the publisher, user growth rate of the publisher, user composition of the publisher, user evaluation of the publisher and network throughput of the publisher. The features of the web site may comprise e.g., click through rate of the web site, average user browsing time of the web site, and category of the web site such as sports, news, car, or entertainment. The analyzed information may be valuable to the advertisers. For example, an advertiser may prefer an ad impression located at a headline of a web site better than an ad impression located at a corner of the web site.

All of the above analyzed information may be sent to the bid control module 320 for determining whether to participate in online bidding in response to the bid request. The bid control module 320 may retrieve bid historical data from the bid history database 350 and determine whether to participate the online bidding based on the bid historical data, which includes information from previous online bidding events at the ad exchange engine 140.

The bid historical data can be stored and analyzed offline, i.e., before or without receiving any bid request from the network 120, or even when disconnected from the network 120. Thus, if it is determined not to participate in online bidding based on the bid historical data analyzed offline, big cost can be avoided by not running the real-time online bidding.

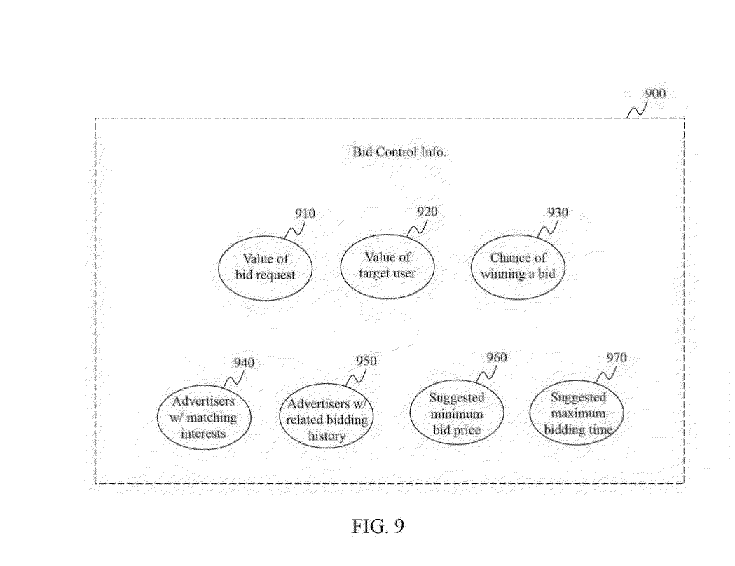

Even if it is determined to participate in online bidding, cost can still be avoided by qualifying the online bidding with some bid control information. In one embodiment, the bid control module 320 evaluates the historical data and the analyzed data to generate bid control information for controlling an online bidding in response to the bid request. FIG. 9 shows exemplary types of information included in bid control information 900, according to an embodiment of the present teaching. In this embodiment, the bid control information 900 includes value of bid request 910, value of target user 920, chance of winning a bid 930, advertisers with matching interests 940, advertisers with related bidding history 950, suggested minimum bid price 960, and suggested maximum bidding time 970.

The value of bid request 910 can be determined based on value of the ad impression, value of the publisher, and value of the web site, in accordance with the analyzed information. The values are evaluated by how interesting or how important they are to the advertisers managed by the ad exchange engine 140, based on the advertisers' bidding history. The value of bid request 910 can indicate how likely a user will pay attention to an ad associated with the ad impression and the bid request.

The value of target user 920 can indicate how likely a target user who views an ad associated with the bid request will buy or consider buying a product or service related to the ad. The value of target user 920 can be determined based on user information such as age, gender, browsing history, purchasing history, credit record, etc. The user information may be obtained from the publisher or collected by the ad exchange engine 140 itself.

The chance of winning a bid 930 can indicate how likely the bid submitted by the ad exchange engine 140 can win at the publisher or the SSP, if an online bidding is performed within the ad exchange engine 140 among the advertisers 150 in response to the bid request. The chance of winning a bid 930 may be determined based on the advertisers' bidding history and the analyzed information associated with the bid request.

Whether to participate in online bidding can be determined based on bid control information such as value of bid request 910, value of target user 920, and chance of winning a bid 930. For example, if value of bid request 910 or value of target user 920 is lower than a first threshold or if chance of winning a bid 930 is smaller than a second threshold, it can be determined not to participate in the online bidding in response to the bid request. On the other hand, if value of bid request 910 or value of target user 920 is higher than the first threshold or if chance of winning a bid 930 is larger than the second threshold, it can be determined to participate in the online bidding in response to the bid request. In one embodiment, the bid control information 900 may also include the determination itself regarding whether to participate in online bidding.

The bid control module 320 not only can determine whether to bid, but also can suggest a more focused and more efficient way to bid. For example, the bid control module 320 may generate bid control information related to advertisers with matching interests 940, advertisers with related bidding history 950, suggested minimum bid price 960, and suggested maximum bidding time 970. The advertisers with matching interests 940 represent advertisers who have interests matching the bid request or the ad impression, based on the advertisers' bidding history. The advertisers with related bidding history 950 represent advertisers who had submitted at least one bid in response to a previous bid request that is similar to or related to the current bid request, based on the advertisers' bidding history. The bid control module 320 may determine to run an internal bidding only among the advertisers with matching interests 940, or advertisers with related bidding history 950, or advertisers satisfying both conditions. The suggested minimum bid price 960 represent a minimum bid price for the online bidding suggested by the bid control module 320, based on the analyzed information and the bid historical data. The suggested maximum bidding time 970 represent a maximum bidding time for the online bidding suggested by the bid control module 320, based on the analyzed information and the bid historical data. The bid control module 320 may help to reduce the time and cost of the online bidding by providing the suggested minimum bid price 960 and/or the suggested maximum bidding time 970, to the bid server 330.

After determining to participate in online bidding, the bid control module 320 can send the bid control information to the bid server 330 to perform an online bidding. Otherwise, after determining not to participate in online bidding, the bid control module 320 can directly generate a bid response to the publisher or the SSP to indicate that no bid is submitted in response to the bid request. In one example, the bid response in this situation can also indicate the reason that no bid is submitted, e.g., location of the ad impression is not good; value of the target user is low; or other reasons based on bid control information.

After generating the bid control information, the bid control module 320 may store the bid control information into the bid history database 350 for future use.

The bid server 330 is configured for performing online bidding among the advertisers 150 managed by the ad exchange engine 140, based on the bid control information sent by the bid control module 320. In one embodiment, the bid server 330 may retrieve information associated with all advertisers or advertisers specified by the bid control information, from the ad database 370. The bid server 330 may automatically run the online bidding based on advertiser information stored in the ad database 370, such as price each advertiser is willing to bid for a given impression. The bid server 330 may determine a bid for each advertiser managed by the ad exchange engine 140 and select the best or highest bid to return to the publisher or the SSP who sent the bid request. If the returned bid is accepted as a winner at the publisher, an ad or its uniform resource locator (URL) associated with the returned bid will be retrieved from the ad database 370 and sent to the publisher to be included in the web site having the ad impression.

In another embodiment, there is an advertiser, e.g., 150-1, who was managed by the ad exchange engine 140 and registered at the ad exchange engine 140 but did not store its ad/advertiser information at the ad exchange engine 140 or in the ad database 370. In this case, the bid server 330 may send a request to the advertiser 150-1 to ask for a bid, if an online bidding is determined among advertisers including the advertiser 150-1.

The online bid generated by the bid server 330 from the online bidding may be first forwarded to the bid control module 320. The bid control module 320 can then generate a bid response based on the online bid and send the bid response to the publisher or the SSP. After each online bidding event, the bid server 330 may store bidding data into the bid history database 350 for future use. The bidding data may include any data generated during online bidding events at the bid server 330. The bid historical data in the bid history database 350 can be updated based on the bidding data generated during one or more recent bidding events that happened after a previous update of the bid history database 350.

As customers for the ad exchange engine 140, the advertisers 150 may be interested in both short term benefits with respect to a one-time online bidding and long term benefits with respect to bid acceptance rate, closing percentage, etc. Bid control information can be utilized to obtain short term benefits for the current online bidding such as saving cost or improving chance of winning by suggesting minimum bid price and specifying advertisers with matching interests. The long term benefits can be obtained when the ad exchange engine 140 sends reports to the advertisers 150, to inform them the bidding historical data related to their bids. For example, a report to an advertiser 150-1 may include information related to one or more bidding events joined by the advertiser 150-1, such as bid price of the advertiser 150-1 in the bidding events, the winning bid price in the bidding events, features of most popular ad impressions, number of bids received for the most popular impressions, etc. The information in the report may be utilized by the advertiser 150-1 to modify its bidding strategy in the future for improving its bid acceptance rate, i.e., the rate at which its bid will be accepted as a winning bid.

In addition, reports can be sent from the ad exchange engine 140 to publishers 130, maybe via their corresponding SSP. A report to a publisher, e.g., publisher 130-1, may include information related to one or more bidding events triggered by bid requests from the publisher 130-1, such as the winning bid price in the bidding events, ad impressions receiving most number of bids, ad impressions receiving least number of bids or no bids, etc. The information in the report may be utilized by the publisher 130-1 to modify its bid soliciting strategy in the future for improving its closing percentage, i.e., the percentage at which its bid request will successfully solicit a bid to close an ad deal.

The reporting module 340 is configured for generating one or more reports based on the historical data retrieved from the bid history database 350. The reports can include both a first report to an advertiser and a second report to a publisher.

In one embodiment, the reporting module 340 retrieves bid historical data from the bid history database 350 and ad/advertiser information from the ad database 370. The bid historical data retrieved are related to bidding events joined by an advertiser, e.g., advertiser 150-1. The ad/advertiser information includes information associated with the advertiser 150-1, such as features of ads stored in the ad database 370 by the advertiser 150-1, personal or demographic information of the advertiser 150-1, bidding strategy or prices stored in the ad database 370 by the advertiser 150-1, etc. Based on the bid historical data and the ad/advertiser information related to the advertiser 150-1, a personalized advertiser report may be generated by the reporting module 340 for the advertiser 150-1. The personalized advertiser report can be generated and sent to the advertiser 150-1, either periodically like every month, or upon request e.g. by the advertiser 150-1.

In another embodiment, the reporting module 340 retrieves bid historical data from the bid history database 350 and publisher information from the publisher database 360. The bid historical data retrieved are related to bidding events initiated by a publisher, e.g., publisher 130-1. The publisher information includes information associated with the publisher 130-1, such as predetermined requirements of bid requests of the publisher 130-1, personal or demographic information of the publisher 130-1, etc. Based on the bid historical data and the publisher information related to the publisher 130-1, a personalized publisher report may be generated by the reporting module 340 for the publisher 130-1. The personalized publisher report can be generated and sent to the publisher 130-1, either periodically like every month, or upon request e.g. by the publisher 130-1.

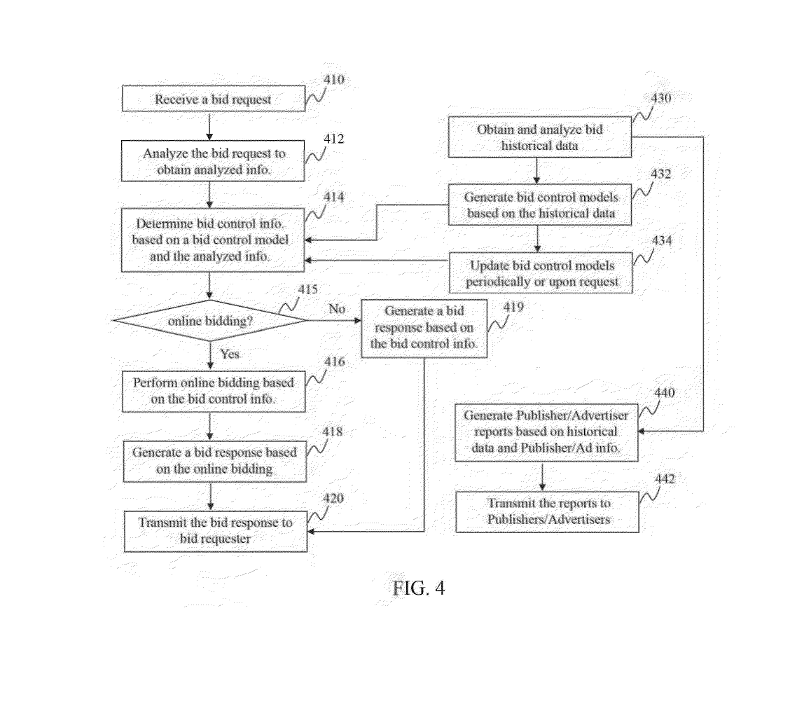

FIG. 4 is a flow chart of an exemplary process for managing online bidding, in accordance with one embodiment of the present teaching. At 410, a bid request is received, e.g. at the ad exchange engine 140, for an ad impression available at a publisher. At 412, the bid request is analyzed to obtain analyzed information. As discussed above, the analyzed information may include but not limited to features of the ad impression, features of the publisher, and features of web site including the ad impression.

At 414, bid control information may be determined based on a bid control model and the analyzed information. The bid control model can be generated at 432 based on bid historical data, where the bid historical data have been obtained and analyzed at 430. As discussed above, the bid control information may include information associated with e.g. value of bid request, value of target user, chance of winning a bid, etc. The bid control model can be utilized to determine a score for each of the bid control information. For example, chance of winning a bid may be determined to be a score between 0 and 1, where 0 represents no chance to win and 1 represents 100% chance to win. In some embodiments, one or more bid control models may be generated based on bid historical data and the ad exchange engine 140 may select one bid control model to determine bid control information. At 434, the one or more bid control models are updated, either periodically like every day or upon request by e.g. the ad exchange engine 140. The processes at 430, 432, and 434 can be performed offline, i.e., before or without receiving any bid request from the network, or even when disconnected from the network.

At 415, it is determined whether to participate in online bidding, based on some bid control information and some predetermined criteria. For example, if the score determined for chance of winning a bid is greater than a predetermined threshold, it is determined to participate in online bidding for the bid request. Otherwise, if the score determined for chance of winning a bid is not greater than the predetermined threshold, it is determined not to participate in online bidding for the bid request.

If it is determined to participate in online bidding, the process moves from 415 to 416, where online bidding is performed at the ad exchange engine 140 based on the bid control information. At 418, a bid response can be generated based on the online bidding, where the bid response may include a bid selected from the online bidding performed at the ad exchange engine 140. At 420, the bid response is transmitted to bid requester, i.e., the publisher or its SSP.

If it is determined not to participate in online bidding, the process moves from 415 to 419, where a bid response is generated based on the bid control information. The bid response may include an indication that no bid is submitted at the ad exchange engine 140 for the bid request, e.g., may be a “no-bid” response. In one embodiment, there is no distinction to the publisher between a first “no-bid” response determined before performing the online bidding and a second “no-bid” response determined after performing the online bidding where no bid is submitted by any advertiser. But the publisher may obtain detailed information regarding this process when receiving reports from the ad exchange engine 140. In another embodiment, the first “no-bid” response can be distinguished from the second “no-bid” response by including some extra indication information.

At 440, one or more publisher reports and one or more advertiser reports are generated based on historical data. As discussed above, each of these reports can be personalized based on publisher information or ad/advertiser information. At 442, the generated one or more reports are sent to publishers and/or advertisers. The processes at 440 and 442 can be performed either periodically like every month or every day, or upon request e.g. by the publishers and/or advertisers.

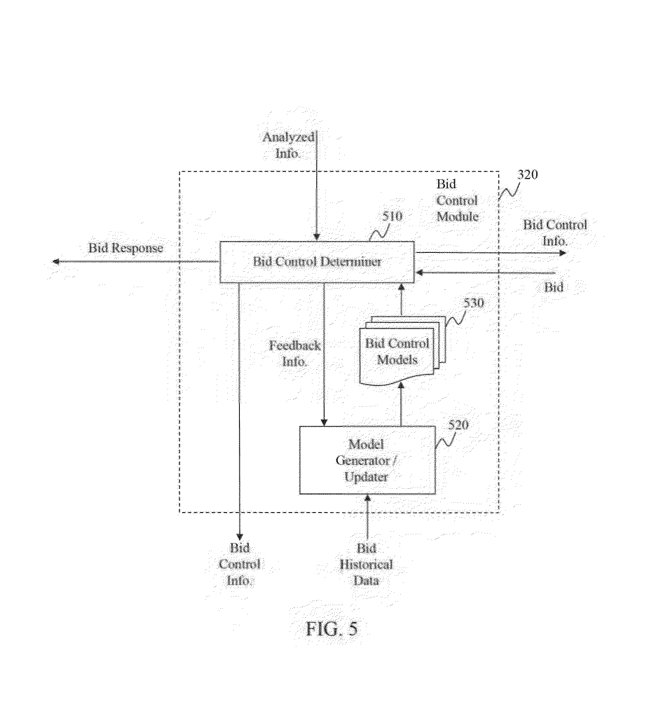

FIG. 5 depicts a high level exemplary system diagram of a bid control module 320, according to an embodiment of the present teaching. The bid control module 320 in this embodiment includes a bid control determiner 510, a model generator/updater 520, and one or more bid control models 530. The model generator/updater 520 may be configured for obtaining and analyzing bid historical data stored in the bid history database 350. The bid historical data may be analyzed to indicate features of a typical ad impression that is valuable to the advertisers 150 and features of a typical ad impression that is not interesting to any advertisers 150.

The model generator/updater 520 can be either a generator or an updater. As a generator, it is configured for generating and storing one or more bid control models 530 based on the bid historical data. As an updater, it is configured for updating and storing the one or more bid control models 530 based on the feedback information received from the bid control determiner 510. The feedback information may include information related newly happened bidding events at the ad exchange engine 140 or new bid control determinations made at the bid control determiner 510, where the feedback information can indicate that a bid control model needs an update to give a better prediction of some bid control information such as chance of winning a bid.

For example, a bid control model is utilized to determine a score for chance of winning a bid, between 0 and 1, where 0 represents no chance to win and 1 represents 100% chance to win. The bid control model may be overestimating the scores, if many or most bid requests received scores very close to 1, entered online bidding at the ad exchange engine 140, but obtained no bid or very low bid from the online bidding. On the other hand, the bid control model may be underestimating the scores, if many or most bid requests received scores very close to 0, did not enter online bidding at the ad exchange engine 140, but some similar bid requests entering the online bidding obtained a large amount of high bids. In either of the above two situations, feedback information can be sent to the model generator/updater 520 to update the bid control model 530.

The bid control determiner 510 is configured for determining bid control information based on a bid control model and analyzed information. The bid control determiner 510 may receive analyzed information associated with a bid request from the bid request analyzer 310. As discussed above, the analyzed information may include but not limited to features of the ad impression, features of the publisher, and features of web site including the ad impression. The bid control determiner 510 may select one of the bid control models 530 to generate bid control information, in accordance with the analyzed information associated with the bid request. In one embodiment, there are multiple bid control models 530, each generated based on a different group of advertisers or according to a different degree of cost saving. For example, a first bid control model in accordance with a high degree of cost saving may underestimate a chance of winning and hence reduce or shed many bidding events to save cost; and a second bid control model in accordance with a low degree of cost saving may overestimate a chance of winning and hence may not reduce or shed as many bidding events as those reduced by the first bid control model. The bid control determiner 510 may select one of the bid control models 530, based on which group of advertisers have best matched interests to the ad impression and/or how much cost saving is needed for the bid request.

The bid control determiner 510 can determine whether the bid server should perform online bidding among the advertisers 150, based on the bid control information or based directly on the bid control model. As discussed above, the bid control information may include information associated with e.g. value of bid request, value of target user, chance of winning a bid, etc. The bid control determiner 510 may determine whether the bid server should perform online bidding among the advertisers 150, based on whether chance of winning a bid is greater than a predetermined threshold.

If the bid control determiner 510 determines that an online bidding is needed for the bid request, the bid control determiner 510 sends the bid control information to the bid server 330. The bid server 330 may perform the online bidding to generate an online bid, according to the bid control information, e.g., among advertisers who have bidding history related to the bid request or advertisers who have submitted bids to requests similar to the current bid request. The generated online bid can be sent from the bid server 330 to the bid control determiner 510. The bid control determiner 510 may then generate and send a bid response to the publisher or the SSP, based on the online bid.

If the bid control determiner 510 determines that an online bidding is not needed for the bid request, the bid control determiner 510 may directly generate and send a bid response to the publisher or the SSP, to indicate no bid is submitted in response to the bid request.

The bid control determiner 510 may send feedback information to the model generator/updater 520 for updating a bid control model. The bid control determiner 510 may also store the bid control information into the bid history database 350 for future use.

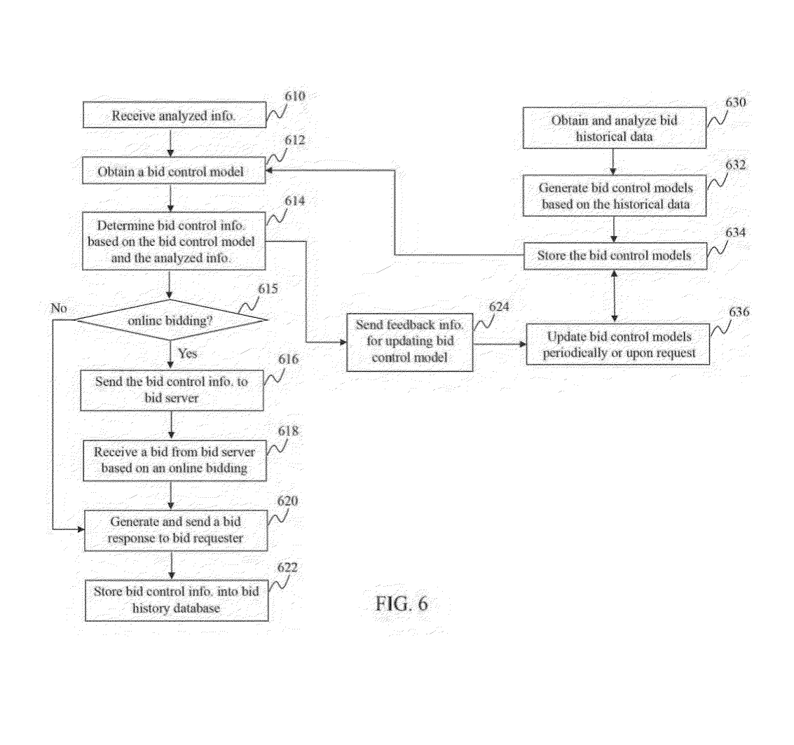

FIG. 6 is a flow chart of an exemplary process performed at a bid control module, e.g. 320, according to an embodiment of the present teaching. At 610, analyzed information associated with a bid request is received at the bid control module 320. At 612, a bid control model is obtained by the bid control module 320, e.g. by selecting one of the bid control models 530.

The bid control models have been generated at 632 based on bid historical data and stored at 634 in the bid control module 320. The bid historical data may be obtained and analyzed at 630. It can be understood that in some embodiments, the processes 630, 632, and 634 can be performed offline, i.e., before or without receiving any bid request from the network, or even when disconnected from the network.

At 614, bid control information can be determined based on the bid control model and the analyzed information. At 624, feedback information may be sent to the model updater 520 for updating one or more bid control models at 636. The update of the bid control models at 636 can be performed periodically or upon request by e.g. the bid control determiner 510.

At 615, it is determined whether to participate in online bidding, based on some bid control information and some predetermined criteria. For example, if the score determined for chance of winning a bid is greater than a predetermined threshold, it is determined to participate in online bidding for the bid request. Otherwise, if the score determined for chance of winning a bid is not greater than the predetermined threshold, it is determined not to participate in online bidding for the bid request.

If it is determined to participate in online bidding, the process moves from 615 to 616, where the bid control information is sent to the bid server for running an online bidding based on the bid control information. At 618, a bid is received from the bid server, where the bid is generated or selected from the online bidding. Proceeding to 620, a bid response is generated and sent to the bid requester or the publisher.

If it is determined not to participate in online bidding, the process moves from 615 to 620 directly, where a bid response is generated and sent to the bid requester or the publisher. The bid response may include an indication that no bid is submitted at the ad exchange engine 140 for the bid request. At 622, the bid control information may be stored into the bid history database 350.

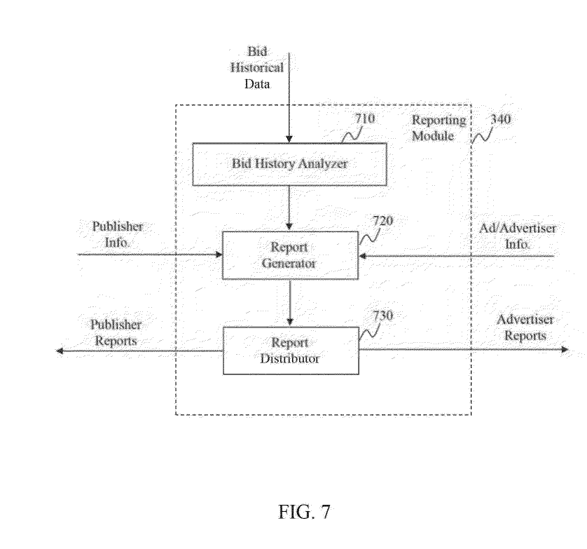

FIG. 7 depicts a high level exemplary system diagram of a reporting module 340, according to an embodiment of the present teaching. The reporting module 340 in this embodiment includes a bid history analyzer 710, a report generator 720, and a report distributor 730. The bid history analyzer 710 may be configured for receiving and analyzing bid historical data from the bid history database 350. The bid historical data may be analyzed to obtain information related to bidding events joined by an advertiser or information related to bidding events initiated by a publisher. The bid history analyzer 710 can send the information to the report generator 720 for generating reports.

The report generator 720 may be configured for generating one or more reports based on the information analyzed from the historical data stored at the bid history database 350. The one or more reports can include an advertiser report to an advertiser or a publisher report to a publisher.

In one embodiment, the report generator 720 generates the advertiser report to an advertiser based on ad/advertiser information retrieved from the ad database 370, publisher information retrieved from the publisher database 360, and information related to bidding events joined by the advertiser, such as bid price of the advertiser in the bidding events, the winning bid price in the bidding events, features of most popular ad impressions, number of bids received for the most popular impressions, etc. The ad/advertiser information includes information associated with the advertiser, such as features of ads stored in the ad database 370 by the advertiser, personal or demographic information of the advertiser, bidding strategy or prices stored in the ad database 370 by the advertiser, etc. Based on the ad/advertiser information associated with the advertiser, the report generator 720 may generate a personalized advertiser report for the advertiser.

In another embodiment, the report generator 720 generates the publisher report to a publisher based on ad/advertiser information retrieved from the ad database 370, publisher information retrieved from the publisher database 360, and information related to bidding events initiated by a publisher, such as the winning bid price in the bidding events, ad impressions receiving most number of bids, ad impressions receiving least number of bids or no bids, etc. The publisher information includes information associated with the publisher, such as predetermined requirements of bid requests of the publisher, personal or demographic information of the publisher, etc. Based on the publisher information associated with to the publisher, the report generator 720 may generate a personalized publisher report for the publisher.

The report distributor 730 may be configured for sending an advertiser report or a publisher report to a corresponding advertiser or publisher. The advertiser/publisher reports can be generated and sent to advertiser/publisher, either periodically like every month, or upon request e.g. by an advertiser/publisher. The information in an advertiser report may be utilized by the advertiser to modify its bidding strategy in the future for improving its bid acceptance rate, i.e., the rate at which its bid will be accepted as a winning bid. The information in a publisher report may be utilized by the publisher to modify its bid soliciting strategy in the future for improving its closing percentage, i.e., the percentage at which its bid request will successfully solicit a bid to close an ad deal.

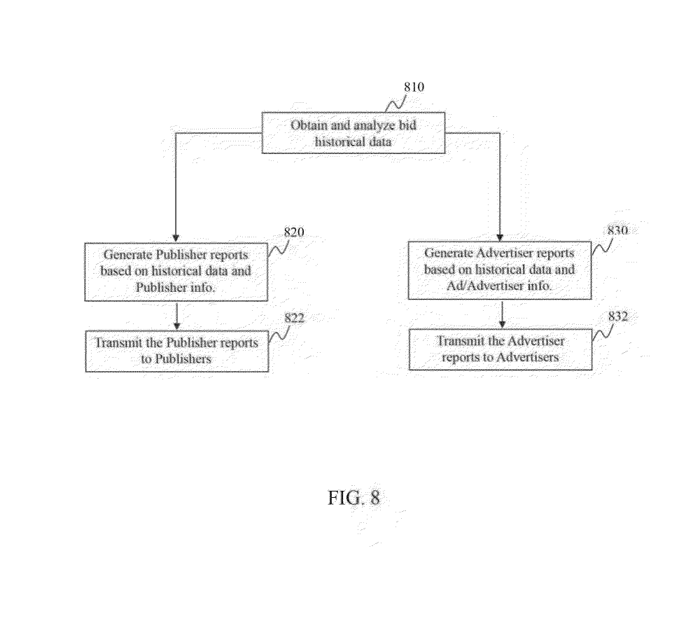

FIG. 8 is a flow chart of an exemplary process performed at a reporting module, e.g. 340, according to an embodiment of the present teaching. At 810, bid historical data may be obtained and analyzed to obtain information related to bidding events joined by an advertiser or information related to bidding events initiated by a publisher. At 820, one or more publisher reports can be generated based on historical data, where the publisher reports may be personalized based on publisher information. At 822, the publisher reports are transmitted to corresponding publishers. At 830, one or more advertiser reports can be generated based on historical data, where the advertiser reports may be personalized based on advertiser information. At 822, the advertiser reports are transmitted to corresponding advertisers.

It can be understood that in some embodiments, the processes 820 and 822 can be performed in parallel to the processes 830 and 832.

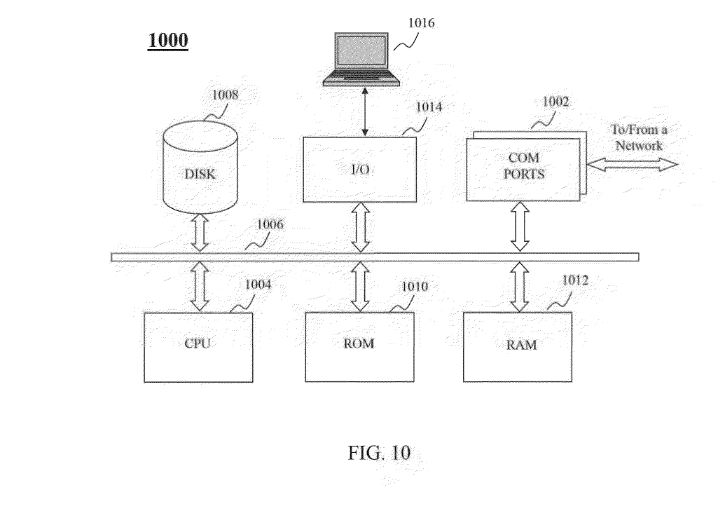

FIG. 10 depicts a general computer architecture on which the present teaching can be implemented and has a functional block diagram illustration of a computer hardware platform which includes user interface elements. The computer may be a general-purpose computer or a special purpose computer. This computer 1000 can be used to implement any components of the system for managing online bidding as described herein. Different components of the system 100, 200, e.g., as depicted in FIGS. 1 and 2, can all be implemented on one or more computers such as computer 1000, via its hardware, software program, firmware, or a combination thereof. Although only one such computer is shown, for convenience, the computer functions relating to dynamic relation and event detection may be implemented in a distributed fashion on a number of similar platforms, to distribute the processing load.

The computer 1000, for example, includes COM ports 1002 connected to and from a network connected thereto to facilitate data communications. The computer 1000 also includes a central processing unit (CPU) 1004, in the form of one or more processors, for executing program instructions. The exemplary computer platform includes an internal communication bus 1006, program storage and data storage of different forms, e.g., disk 1008, read only memory (ROM) 1010, or random access memory (RAM) 1012, for various data files to be processed and/or communicated by the computer, as well as possibly program instructions to be executed by the CPU. The computer 1000 also includes an I/O component 1014, supporting input/output flows between the computer and other components therein such as user interface elements 1016. The computer 1000 may also receive programming and data via network communications.

Hence, aspects of the method for managing online bidding, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the computer-implemented method.

All or portions of the computer-implemented method may at times be communicated through a network such as the Internet or various other telecommunication networks. Such communications, for example, may enable loading of the software from one computer or processor into another. Thus, another type of media that may bear the elements of the computer-implemented method includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the computer-implemented method. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teaching is amenable to a variety of modifications and/or enhancements. For example, although the implementation of various components described above may be embodied in a hardware device, it can also be implemented as a firmware, firmware/software combination, firmware/hardware combination, or a hardware/firmware/software combination.

While the foregoing description and drawings represent embodiments of the present teaching, it will be understood that various additions, modifications, and substitutions may be made therein without departing from the spirit and scope of the principles of the present teaching as defined in the accompanying claims. One skilled in the art will appreciate that the present teaching may be used with many modifications of form, structure, arrangement, proportions, materials, elements, and components and otherwise, used in the practice of the disclosure, which are particularly adapted to specific environments and operative requirements without departing from the principles of the present teaching. The presently disclosed embodiments are therefore to be considered in all respects as illustrative and not restrictive, the scope of the present teaching being indicated by the appended claims and their legal equivalents, and not limited to the foregoing description.

What is claimed is:

1. A method, implemented on a machine having at least one processor, storage, and a communication platform connected to a network for managing online bidding, comprising:
receiving, via the communication platform, a bid request;
analyzing the bid request to obtain information associated with the request;
determining whether to participate in online bidding based on a bid control model in accordance with the information associated with the request, wherein the bid control model is generated based on historical data associated with one or more previous online bidding events;
generating an online bid if it is determined to participate in the online bidding; and
transmitting the online bid as a response to the bid request.

2. The method of claim 1, further comprising:
generating a bid response if it is determined not to participate in the online bidding, wherein the bid response indicates no online bid is submitted for the bid request; and
transmitting the bid response as a response to the bid request.

3. The method of claim 1, further comprising:
generating a first report based on the historical data and information associated with a first user who sends the bid request; and
transmitting the first report to the first user.

4. The method of claim 1, further comprising:
generating a second report based on the historical data and information associated with a second user who joins the online bidding; and
transmitting the second report to the second user.

5. The method of claim 1, further comprising determining bid control information if it is determined to participate in the online bidding, wherein the online bid is generated based on the bid control information.

6. The method of claim 5, wherein the bid control information is determined based on historical data and includes information associated with at least one of:
value of the bid request, value of a target user with respect to the bid, and chance of winning the bid.

7. The method of claim 5, wherein the historical data is updated, periodically or upon request, based on the bid control information and the online bidding.

8. The method of claim 1, wherein the bid control model is updated, periodically or upon request, based on feedback information generated when determining whether to participate in online bidding.

9. A system, having at least one processor, storage, and a communication platform connected to a network for managing online bidding, comprising:
a bid request analyzer configured for:
receiving, via the communication platform, a bid request, and
analyzing the bid request to obtain information associated with the request;
a bid control module configured for determining whether to participate in online bidding based on a bid control model in accordance with the information associated with the request, wherein the bid control model is generated based on historical data associated with one or more previous online bidding events; and
a bid server configured for generating an online bid if it is determined to participate in the online bidding, wherein the online bid is transmitted as a response to the bid request.

10. The system of claim 9, wherein the bid control module is further configured for:
generating a bid response if it is determined not to participate in the online bidding, wherein the bid response indicates no online bid is submitted for the bid request; and
transmitting the bid response as a response to the bid request.

11. The system of claim 9, further comprising a reporting module configured for:
generating a first report based on the historical data and information associated with a first user who sends the bid request; and
transmitting the first report to the first user.

12. The system of claim 9, further comprising a reporting module configured for:
generating a second report based on the historical data and information associated with a second user who joins the online bidding; and
transmitting the second report to the second user.

13. The system of claim 9, wherein the bid control module is further configured for determining bid control information if it is determined to participate in the online bidding, wherein the online bid is generated based on the bid control information.

14. The system of claim 13, wherein the bid control information is determined based on historical data and includes information associated with at least one of:
value of the bid request, value of a target user with respect to the bid, and chance of winning the bid.

15. A machine-readable tangible and non-transitory medium having information for managing online bidding, wherein the information, when read by the machine, causes the machine to perform the following:
receiving, via the communication platform, a bid request;
analyzing the bid request to obtain information associated with the request;
determining whether to participate in online bidding based on a bid control model in accordance with the information associated with the request, wherein the bid control model is generated based on historical data associated with one or more previous online bidding events;
generating an online bid if it is determined to participate in the online bidding; and
transmitting the online bid as a response to the bid request.

16. The medium of claim 15, the information, when read by the machine, further causing the machine to perform the following:
generating a bid response if it is determined not to participate in the online bidding, wherein the bid response indicates no online bid is submitted for the bid request; and
transmitting the bid response as a response to the bid request.

17. The medium of claim 15, the information, when read by the machine, further causing the machine to perform the following:
generating a first report based on the historical data and information associated with a first user who sends the bid request; and
transmitting the first report to the first user.

18. The medium of claim 15, the information, when read by the machine, further causing the machine to perform the following:
generating a second report based on the historical data and information associated with a second user who joins the online bidding; and
transmitting the second report to the second user.

19. The medium of claim 15, the information, when read by the machine, further causing the machine to determine bid control information if it is determined to participate in the online bidding, wherein the online bid is generated based on the bid control information.

20. The medium of claim 19, wherein the bid control information is determined based on historical data and includes information associated with at least one of:
value of the bid request, value of a target user with respect to the bid, and chance of winning the bid.
